(19) United States
(12) Patent Application Publication
(10) Pub. No.: US 2014/0317077 A1
(43) Pub. Date: Oct. 23, 2014

(54) METHOD AND APPARATUS FOR PROVIDING KNOWLEDGE INFORMATION

(71) Applicant: Teracle, Inc., Seoul (KR)

(72) Inventors: In Je CHO, Seoul (KR); Hoon Je CHO, Seoul (KR)

(73) Assignee: TERACLE, INC., Seoul (KR)

(21) Appl. No.: 14/191,421

(22) Filed: Feb. 27, 2014

(30) Foreign Application Priority Data
Apr. 19, 2013 (KR) 10-2013-0043376
Nov. 1, 2013 (KR) 10-2013-0132533

(51) Int. Cl. G06F 17/30

(52) U.S. Cl. CPC G06F 17/30106
USPC 707/706

(57) ABSTRACT

A method and apparatus for providing knowledge information is provided. The method includes: receiving a search word from a first user terminal; and extracting knowledge information corresponding to the search word according to difficulty levels from a database (DB); and providing the extracted knowledge information to the first user terminal.

### RELATED APPLICATIONS

This application claims priority of Korean Patent Application No. 10-2013-0043376, filed on Apr. 19, 2013, and Korean Patent Application No. 10-2013-0132533, filed on Nov. 1, 2013, in the Korean Intellectual Property Office, the disclosures of which are incorporated herein in their entirety by reference.

### BACKGROUND

1. Field

One or more embodiments of the present invention relate to a method and apparatus for providing knowledge information, and more particularly, to a method and apparatus for uploading useful knowledge information to a knowledge server through a network to provide knowledge information.

2. Description of the Related Art

Knowledge and information are scattered on the Internet, and thus the Internet is referred to as sea of information. However, since a large amount of time and a lot of efforts are invented to search for useful knowledge or information, Internet users, in particular, novice Internet users, have difficulties searching for information.

In order to solve this problem, a knowledge providing service is operated on a portal site, and useful knowledge is provided free, and thus many netizens use the useful knowledge.

However, damage frequently occurs due to knowledge written by a knowledge provider insincerely or without sense of responsibility.

Also, in order to measure the value of knowledge, existing knowledge service sties provide knowledge that are clicked by the large number of times or premium services that are registered on a first page with payments to fix popularity of knowledge. However, this method may not actually assist knowledge consumers. Also, although there is any high-quality encyclopedic knowledge, an elementary school student of a low intellectual level does not need frequently knowledge of a level that is understood by a university student or a highly educated person.

Therefore, there is a need for a knowledge providing service that considers a level of a user who wants to use a knowledge service and provides a reliable criterion.

### SUMMARY

One or more embodiments of the present invention include a method and apparatus for uploading knowledge information from a user to a knowledge server by using a user terminal.

One or more embodiments of the present invention include a method and apparatus for classifying and storing knowledge information stored in a knowledge server according to categories, knowledge levels (difficulty levels).

One or more embodiments of the present invention include a method and apparatus for evaluating knowledge information stored in a knowledge server, giving grades to users who upload the knowledge information according to the evaluation result, and determining a term or accumulated ranking in order to induce many people to further actively upload the knowledge information.

One or more embodiments of the present invention include a method and apparatus for requesting preset payment to a user terminal that downloads knowledge information, according to a request of a user who uploads the knowledge information or a request of a manager who manages a knowledge server.

Additional aspects will be set forth in part in the description which follows and, in part, will be apparent from the description, or may be learned by practice of the presented embodiments.

According to one or more embodiments of the present invention, a method of providing knowledge information in real time through a server, includes: receiving a search word from a first user terminal; and extracting knowledge information corresponding to the search word according to difficulty levels from a database (DB); and providing the extracted knowledge information to the first user terminal.

The providing of the knowledge information may include: providing the first user terminal with a list of the knowledge information extracted according to the difficulty levels; and receiving a difficulty level selected from the list from the first user terminal and providing knowledge information having the selected difficulty level to the first user terminal.

The extracting of the knowledge information may include: determining a classification area to which the search word belongs; and extracting knowledge information corresponding to the search word according to difficulty levels from the determined classification area of the DB.

Knowledge information of each difficulty level may include a plurality of pieces of knowledge information related to the search word.

The method may further include: requesting the first user terminal to evaluate the provided knowledge information and receiving an evaluation result from the first user terminal.

The method may further include: collecting evaluation results of the same knowledge information from a plurality of user terminals and determining a ranking of knowledge information based on the collected evaluation results.

The determining of the ranking of the knowledge information may include: applying different weights to the evaluation results received from the plurality of user terminals to calculate a final evaluation result.

The providing of the knowledge information may include: providing a ranking of the provided knowledge information along with the knowledge information.

The method may further include: receiving a request for registering knowledge information from a user terminal; and storing the requested knowledge information in the DB based on a classification system and a difficulty level.

The receiving of the request for registering the knowledge information may include: receiving a classification area and a difficulty level of the received knowledge information from the second user terminal.

According to one or more embodiments of the present invention, an apparatus for providing knowledge information, includes: a DB which stores knowledge information according to difficulty levels; and a knowledge information extracting module which extracts knowledge information corresponding to a search word received from a first user terminal according to difficulty levels from the DB and provides the extracted knowledge information to the first user terminal.

The knowledge information extracting module may provide the first user terminal with a list of the extracted knowledge information and provide the first user terminal with knowledge information having a difficulty level selected by the first user terminal.

The knowledge information extracting module may determine a classification area to which the search word belongs and extract knowledge information corresponding to the search word according to difficulty levels from the determined classification area of the DB.

Knowledge information of each difficulty level may include a plurality of pieces of knowledge information related to the search word.

The apparatus may further include: an evaluating module which requests the first user terminal to evaluate the provided knowledge information and receives an evaluation result from the first user terminal.

The evaluating module may collect evaluation results of the same knowledge information from a plurality of user terminals and determine a ranking of knowledge information based on the collected evaluation results.

The evaluating module may apply different weights to the evaluation results received from the plurality of user terminals to calculate a final evaluation result.

The evaluating module may provide a ranking of the provided knowledge information.

The apparatus may further include: a knowledge information registering module which receives knowledge information from a second user terminal and stores the received knowledge information in the DB based on a classification system and a difficulty level.

The knowledge information registering module may receive a classification area and a difficulty level of the received knowledge information from the second user terminal.

### BRIEF DESCRIPTION OF THE DRAWINGS

These and/or other aspects will become apparent and more readily appreciated from the following description of the embodiments, taken in conjunction with the accompanying drawings in which:

FIG. 1 a view illustrating a form of knowledge information stored in a knowledge server according to an embodiment of the present invention;

FIG. 2 is a schematic view illustrating a system for providing knowledge information according to an embodiment of the present invention;

FIG. 3 is a flowchart illustrating a process of uploading knowledge information to a knowledge server by using a user terminal, according to an embodiment of the present invention;

FIG. 4 is a flowchart schematically illustrating a method of evaluating knowledge information stored in a knowledge server by using a user terminal, according to an embodiment of the present invention;

FIG. 5 is a schematic block diagram illustrating a structure of a knowledge server, according to an embodiment of the present invention;

FIG. 6 is a flowchart schematically illustrating a method of providing knowledge information in real time through a knowledge server, according to an embodiment of the present invention;

FIG. 7 is a flowchart schematically illustrating a method of registering knowledge information in real time through a knowledge server, according to an embodiment of the present invention; and

FIG. 8 is a flowchart schematically illustrating a method of determining rankings based on evaluation of knowledge information through a knowledge server, according to an embodiment of the present invention.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

It will be understood that, although the terms, ‘first’, ‘second’, etc. may be used herein to describe various elements, these elements should not be limited by these terms. These terms are only used to distinguish one element from another.

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

In the embodiments, “communication”, “communication network”, “Internet”, and “network” may be used as the same meaning. The terms means wire-wireless short-distance and wide area data transmitting and receiving network through which a user terminal, terminals of other users, and a download server transmit and receive data.

Hereinafter, the present invention will be described in detail by explaining embodiments of the invention with reference to the attached drawings. Like reference numerals in the drawings denote like elements.

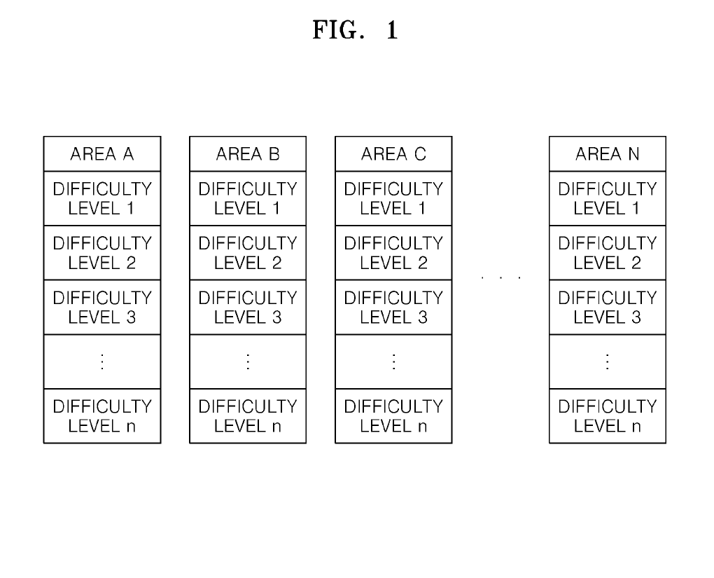

FIG. 1 is a view illustrating a form of knowledge information stored in a knowledge server according to an embodiment of the present invention. The form of the knowledge information stored in the knowledge server will now be described in detail with reference to FIG. 1.

Referring to FIG. 1, the knowledge information stored in the knowledge server is classified and stored according to areas and knowledge levels (difficulty levels). In other words, the knowledge information is classified into areas A, B, C, . . . , and N, each of which is sub-classified into knowledge levels (difficulty levels). In other words, the area A is classified into difficulty levels 1, 2, 3, . . . , and n. Difficulty levels are classified for elementary school students, middle and high school students, university students, and adults but are not limited thereto. In other words, the number of difficulty levels of each area stored in the knowledge server may be variously set. Also, the numbers of difficulty levels of respective areas does not need to be the same and thus may be differently set. In other words, the number of difficulty levels of the area A may be set to 4, and the number of difficulty levels of the area B may be set to 3. As described above, the knowledge server may classify the knowledge information in various forms.

Also, according to the present invention, the knowledge information may be classified into various forms. In other words, the knowledge information may be classified into a hierarchy structure such as large classification, middle classification, small classification, or the like. In other words, according to the large classification, the knowledge information may be classified into science, society, art and physical education, etc. According to the middle classification, the science is classified into biology, earth science, physics, chemistry, etc. The physics may be classified into force and motion, waves, electricity and magnetism, etc. The small classification may be classified into lower classifications, i.e., sub-classifications. The knowledge information may have various forms of hierarch structures.

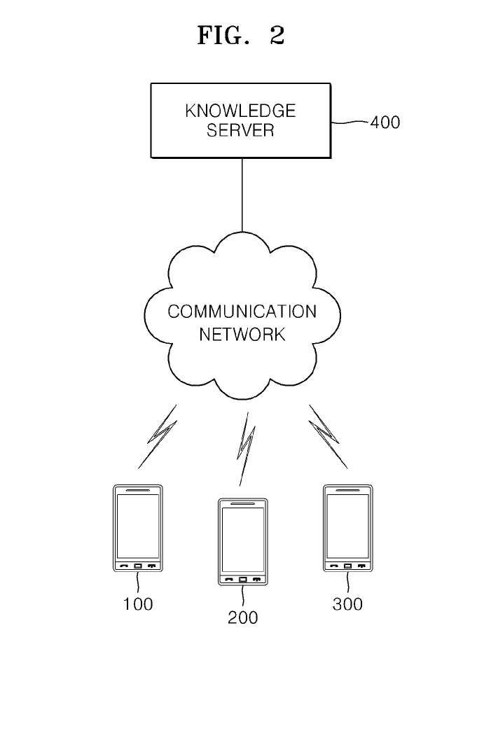

FIG. 2 is a schematic view illustrating a system for providing knowledge information according to an embodiment of the present invention. The system for providing the knowledge information will now be described in detail with reference to FIG. 2.

Referring to FIG. 2, the system includes first, second, and third user terminals 100, 200, and 300 and a knowledge sever 400. The system may further include other types of elements besides the above elements.

The first, second, and third user terminals 100, 200, and 300 may be apparatuses that may access the knowledge server 400 through a communication network such as the Internet, mobile terminals such as notebook computers, hand-held devices, smartphones, taps, or the like, desktop computers, or arbitrary appropriate apparatuses that use these devices or are directly or indirectly connected to these devices.

The first user terminal 100 may be a download terminal that downloads knowledge information from the knowledge server 400. The first user terminal 100 may download knowledge information that is stored (registered) in the knowledge server 400. The first user terminal 100 may access the knowledge server 400 to input a keyword (search word) or may perform a subsequent search in order of large classification, middle classification, and small classification to search for knowledge information. The first user terminal 100 may download necessary knowledge information of the searched knowledge information and evaluate (rate) the downloaded knowledge information. According to a method of evaluating (rating) the knowledge information, the first user terminal 100 may select one of a plurality of classes (grades) or may narratively write a detailed opinion of the corresponding knowledge information to upload the selected class or the detailed opinion to the knowledge sever 400. The first user terminal 100 may receive preset payments for the evaluation.

The second user terminal 200 may be an upload terminal that uploads knowledge information. A user who wants to register knowledge information to the knowledge server 400 may set areas (classification systems) and knowledge levels (difficulty levels) of knowledge information that is to be uploaded to the knowledge server 400 through the second user terminal 200. The areas of the knowledge information have hierarchies such as large, middle, and small classifications, and a user who uploads the knowledge information sets an area that is to be uploaded, by using a hierarchy structure. The second user terminal 200 sets a difficulty level of the knowledge information that is to be uploaded. As described above, the second user terminal 200 sets areas and difficulty levels of knowledge information that is to be uploaded to the knowledge server 400 and uploads the knowledge information to the knowledge server 400. Setting of areas and knowledge levels (difficulty levels) of particular upload knowledge information set by the second user terminal 200 may be arbitrarily changed by an operator.

The second user terminal 200 may be set to request preset payment to another user who downloads the uploaded knowledge information. In other words, the second user terminal 200 may set payment policy to knowledge information to be downloaded by or without fee. If the second user terminal 200 set the payment policy to the knowledge information by fee, the second user terminal 200 may set a detailed price of each uploaded knowledge information.

The first and second user terminals 100 and 200 may be separated terminals that respectively download and upload knowledge information. Also, each of the first and second user terminals 100 and 200 may download and upload knowledge information.

The third user terminal 300 may evaluate the knowledge information stored in the knowledge server 400 according to a request of the knowledge server 400. The third user terminal 300 may be managed and operated by the knowledge server 400 and may be the first user terminal 100 or the second user terminal 200. The third user terminal 300 may be an additional terminal except the first user terminal 100 or the second user terminal 200.

If the third user terminal evaluates the knowledge information, the third user terminal 300 may receive preset payment from the knowledge server 400. For this, the knowledge server 400 may include a user (or a user terminal) that matches with a preset criterion in the third user terminal 300.

The knowledge server 400 is connected to the first, second, and third user terminals 100, 200, and 300 through the communication network.

The knowledge server 400 may be constituted as hardware of a computing device that user terminals access to upload or download knowledge information or may be constituted as software or circuits. One knowledge server 400 may operate a plurality of production programs or one or more knowledge servers 400 for operating may exist according to functions thereof.

At least some of elements constituting the knowledge server 400 may be constituted as software including at least one or more of an operating system (OS), an application program module, and other program modules and may be physically stored in various types of well-known storage units.

The knowledge server 400 may classify and store the knowledge information uploaded by the second user terminal 200 according to areas and difficulty levels or may provide the corresponding knowledge information to the first user terminal 100. The knowledge server 400 may evaluate the stored the knowledge information and a user who uploads the knowledge information, according to areas and difficulty levels by using various evaluation methods. In other words, the knowledge server 400 may collect an evaluation grade received from the first user terminal 100 and an evaluation grade received from the third user terminal 300 to evaluate the knowledge information and the user who uploads the knowledge information. Alternatively, the knowledge server 400 may provide evaluation contents (rating, grade etc.) to the first user terminal 100 or the second user terminal 200. The knowledge server 400 may provide rankings according to areas and knowledge levels (difficulty levels) or may provide weekly, monthly, yearly, or totally accumulated rankings.

For this, the knowledge server 400 may include a storage unit that stores the knowledge information, a controller that calculates rankings (ratings) of the stored knowledge information and the user who uploads the knowledge information, and a communicator that communicates with the first, second, and third user terminals 100, 200, and 300.

As described above, the knowledge server 400 may provide the evaluation contents to the first user terminal 100 and/or the second user terminal 200 to induce the second user terminal 200 to upload high-ranking knowledge information to the knowledge server 400 and may provide reliability of the knowledge information to the first user terminal 100. The first and second user terminals 100 and 200 may be the third user terminals 300.

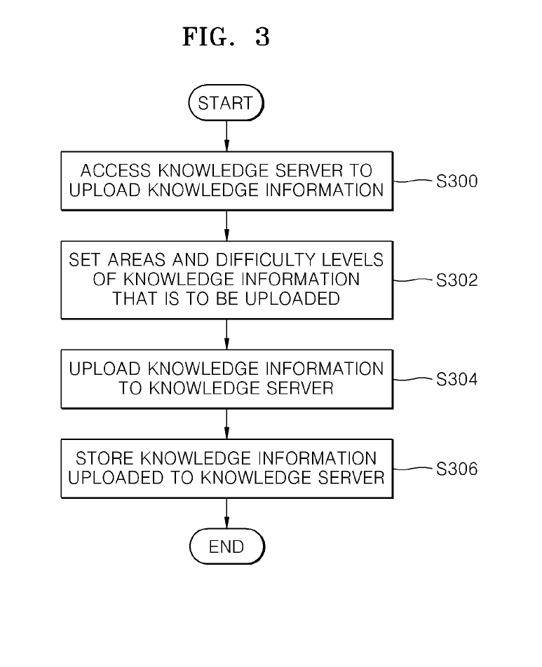

FIG. 3 is a flowchart illustrating a process of uploading knowledge information to a knowledge server by using a user terminal, according to an embodiment of the present invention.

Here, the user terminal may be the second user terminal 200 of FIG. 2 but is not limited thereto. The user terminal may any types of terminals that may upload knowledge information.

In operation S300, the user terminal accesses the knowledge server to request knowledge information to be registered in order to register the knowledge information in the knowledge server. The user terminal may execute an application for accessing the knowledge server.

In operation S302, the user terminal sets areas and difficulty levels of the knowledge information that is to be uploaded to the knowledge server that the user terminal accesses. In other words, the user terminal may first set the areas of the knowledge information to be uploaded and then set the difficulty levels. For example, since areas of the knowledge server have a hierarchy structure, the user terminal may sequentially set areas in which the knowledge information is to be uploaded, in order from a large classification to a small classification. The user terminal may set the areas in which the knowledge information is to be uploaded, by using a search window. After the user terminal sets the areas, the user terminal may set the difficulty levels of the knowledge information that is to be uploaded. The user terminal may not set the difficulty levels of the knowledge information that is to be uploaded, and a manager or the knowledge server may arbitrarily adjust the areas and the knowledge levels (difficulty levels).

In operation S304, the user terminal uploads the knowledge information to the knowledge server that the user terminal accesses.

In operation S306, the knowledge server stores the uploaded knowledge information in a corresponding difficulty level of a corresponding classification area of the storage unit to register the knowledge information. If the user terminal does not set the difficulty levels, the knowledge server may set and store difficulty levels of the knowledge information according to a preset criterion. For example, the knowledge server may set and store automatically uploaded knowledge information on the lowest difficulty level.

The user terminal may be provided with an evaluation grades (ratings) and/or a ranking of the uploaded knowledge information from the knowledge server.

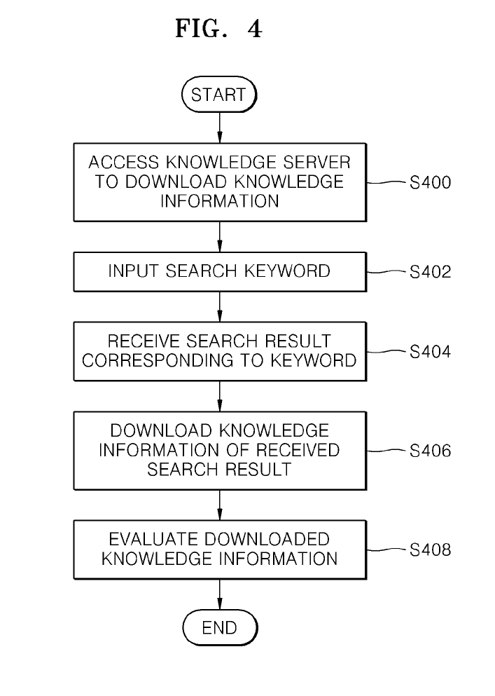

FIG. 4 is a flowchart schematically illustrating a method of evaluating knowledge information stored in a knowledge server by using a user terminal, according to an embodiment of the present invention.

Here, the user terminal may be the first user terminal 100 of FIG. 2 but is not limited thereto. The user terminal may be any types of terminals that may download knowledge information.

In operation S400, the user terminal accesses the knowledge server to download or search for the knowledge information from the knowledge server. The user terminal may execute an application for accessing the knowledge server.

In operation S402, the user terminal inputs a keyword into a search window to download or search for the knowledge information. In this case, the user terminal may set at least one of a classification area and a difficulty level and then input the corresponding keyword. The user terminal may input the keyword without setting the classification area or the difficulty level.

In operation S404, the user terminal receives search results corresponding to the input keyword from the knowledge server and selects necessary one of the received search results. Here, a method of displaying the search results may be set by the manager. However, knowledge information that is more highly evaluated or knowledge of a knowledge upload user who has a high grade may be displayed at the top but is not limited thereto. The user terminal may set and change a method of displaying a search result of particular knowledge according to a desired criterion.

In operation S406, the user terminal checks and downloads contents of a selected search result. The user terminal may be provided with knowledge information from the knowledge server according to difficulty levels or may be provided with only knowledge information having a particular difficulty level. One or more pieces of related knowledge information may be provided to each difficulty level. The user terminal may check (read) or download knowledge information selected from provided knowledge information.

In operation S408, the user terminal evaluates the downloaded search result. The knowledge server pays the price to the user terminal that evaluates the knowledge information. In this case, the knowledge server may pay the price according to the evaluation contents. In other words, the knowledge server may pay the higher price for a narrative evaluation of the corresponding search result than a simple evaluation of the corresponding search result with additional grades or grades. The knowledge server may evaluate the search result by using various methods or may play the price for the evaluation of the search result.

The user terminal may be provided with the knowledge information and an evaluation grade or a ranking of each knowledge information. The ranking of the knowledge information may be at least one of weekly, monthly, yearly, and totally accumulated rankings.

In FIG. 4, knowledge information is evaluated by a user terminal that downloads the corresponding knowledge information, but the present invention is not limited thereto. In other words, a knowledge server may operate an additional evaluation group (for example, the third user terminal 300 of FIG. 2) that evaluates the knowledge information. The knowledge server may request the evaluation group to rate the stored knowledge information, and the evaluation group may rate the requested knowledge information. Besides this, the knowledge server may rate the knowledge information based on an amount of knowledge information that is uploaded by the user terminal (or an uploader). In other words, the knowledge server may highly rate a user terminal that uploads a large amount of knowledge information and may low rate a user terminal that uploads a small amount of knowledge information.

The knowledge server may evaluate the knowledge information by using various methods. If at least two evaluation methods are used, the knowledge server may apply different weights to the two methods. In other words, the knowledge server may apply a higher weight to an evaluation grade given by a user who downloads the knowledge information than an evaluation grade given by an evaluation group (or an evaluation group terminal) or may apply a higher weight to the evaluation grade given by the evaluation group than the evaluation grade given by the user. Besides this, the knowledge server may evaluate knowledge information by using various methods.

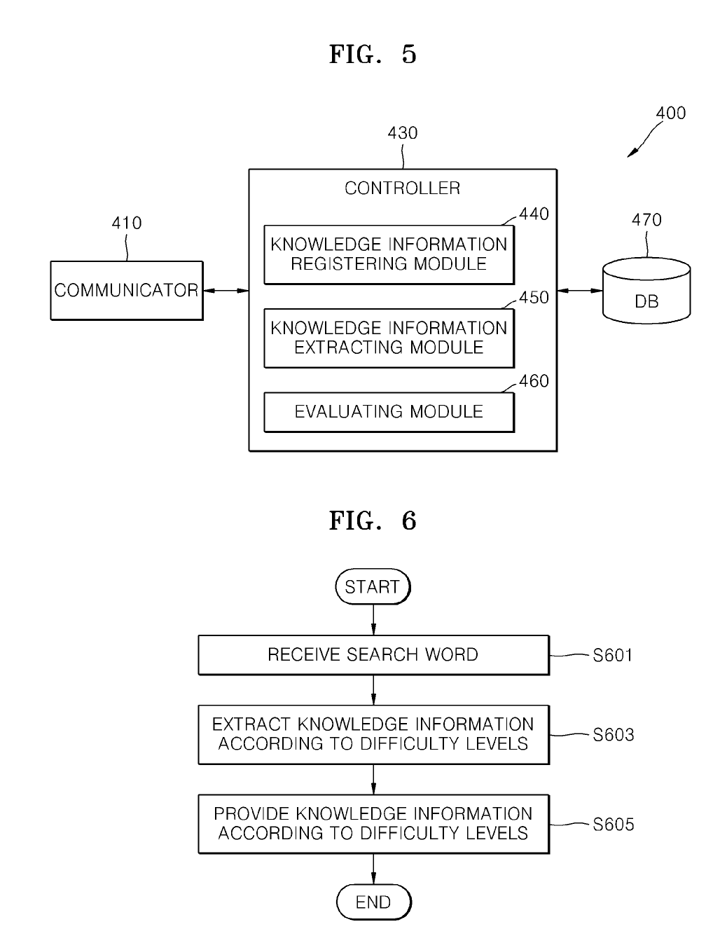

FIG. 5 is a schematic block diagram illustrating a structure of the knowledge server 400, according to an embodiment of the present invention.

The knowledge server 400 may classify and store knowledge information provided from an upload terminal according to areas and knowledge levels (difficulty levels), calculate a ranking of knowledge information or a user who uploads the knowledge information within a corresponding area and a difficulty level by using at least two evaluation contents including evaluation contents of knowledge information provided from a download terminal, be provided with the knowledge information from the upload terminal, provide the knowledge information to the download terminal, and receive evaluation contents of the provided knowledge information.

Referring to FIG. 5, the knowledge server 400 includes a communicator 410, a controller 430, and a database (DB) 470.

The communicator 410 may communicate with the first user terminal 100 that downloads the knowledge information, the second user terminal 200 that uploads the knowledge information, and the third user terminal 300 that evaluates the knowledge information. The first, second, and third user terminals 100, 200, and 300 may be terminals that respectively perform functions or may be integrated into one terminal to perform two or more of functions of the first, second, and third terminals 100, 200, and 300.

The communicator 410 may receive knowledge information from the second user terminal 200, transmit the knowledge information to the controller 430, and provide the knowledge information received from the controller 430 to the first user terminal 100. The communicator 410 may receive an evaluation result from the third user terminal 300, transmit the evaluation result to the controller 430, and provide a ranking of the knowledge information received from the controller 430 to the first user terminal 100 and/or the second user terminal 200.

The controller 430 may include a knowledge information registering module 440, a knowledge information extracting module 450, and an evaluating module 460. Here, a module refers to a logical combination of general-purpose hardware and/or software.

The knowledge information registering module 440 may receive knowledge information from the second user terminal 200 and store the received knowledge information in the DB 470 based on a classification system and a difficulty level to register the knowledge information. The knowledge information registering module 440 may receive classification areas and difficulty levels of the knowledge information along with the knowledge information from the second user terminal 200.

The knowledge information extracting module 450 may receive a search word from the first user terminal 100 and extract knowledge information corresponding to the received search word according to difficulty levels from the DB 470. The knowledge information extracting module 450 may determine a classification area to which the search word belongs and extract knowledge information corresponding to the search word according to difficulty levels from the corresponding classification area of the DB 470. The knowledge information extracting module 450 may extract a plurality of pieces of knowledge information related to the search word from one difficulty level.

The knowledge information extracting module 450 may provide the first user terminal 100 with the knowledge information that is extracted according to the difficulty levels. Here, the knowledge information extracting module 450 may provide the first user terminal 100 with a list of knowledge information that is extracted according to the difficulty levels and provide the first user terminal 100 with knowledge information of a selected difficulty level.

The evaluating module 460 may request the first user terminal 100 and/or the third user terminal 300 to evaluate the knowledge information and receive evaluation results from the first user terminal 100 and/or the third user terminal 300. The evaluating module 460 may collect evaluation results of the same knowledge information from the first and third user terminals 100 and 300 and a plurality of user terminals and may determine a ranking of each knowledge information based on the collected evaluation results. The evaluating module 460 may provide the determined ranking of each knowledge information to the first user terminal 100 and/or the second user terminal 200.

The DB 470 is a storing unit that stores knowledge information. The DB 470 may be classified into a plurality of areas according to a classification system of the knowledge information, and each of the plurality of areas may be classified into a plurality of difficulty levels. The knowledge information may be stored to correspond to a corresponding difficulty level of a corresponding area of the DB 470. The DB 470 may have a hierarchy structure that is classified into at least two layers including an uppermost layer and a lowermost layer, and the knowledge information may be stored to correspond to one of the uppermost layer and the lower most layer.

FIG. 6 is a flowchart schematically illustrating a method of providing knowledge information in real time through a knowledge server, according to an embodiment of the present invention.

Referring to FIG. 6, in operation S601, the knowledge server 400 receives a search word from the first user terminal 100. The knowledge server 400 may receive the search word and a difficulty level of knowledge information with which the knowledge server 400 may be provided, from the first user terminal 100.

In operation 603, the knowledge server 400 extracts knowledge information corresponding to the received search word according to difficulty levels from the DB 470. The knowledge server 400 may determine a classification area to which the search ward belongs and extract knowledge information corresponding to the search word from the corresponding classification area of the DB 470. The knowledge server 400 may extract a plurality of pieces of knowledge information related to the search word from one difficulty level. The knowledge server 400 may extract only knowledge information of a set difficulty level.

In operation S605, the knowledge server 400 provides the first user terminal 100 with the knowledge information extracted according to the difficulty levels. The knowledge server 400 may provide a difficulty level list of the knowledge information to the first user terminal 100 and provide the first user terminal 100 with knowledge information corresponding a difficulty level selected by the first user terminal 100. The knowledge server 400 may provide a plurality of pieces of knowledge information having difficult level selected by the first user terminal 100, and the first user terminal 100 may select particular one of the plurality of pieces of knowledge information. The knowledge server 400 may not provide the difficulty level list and provide only knowledge information corresponding to a difficulty level selected by the first user terminal 100 or provide the knowledge information corresponding to the difficulty level selected by the first user terminal 100 along with knowledge information having other difficulty levels to allow the user to select the knowledge information having other difficulty levels.

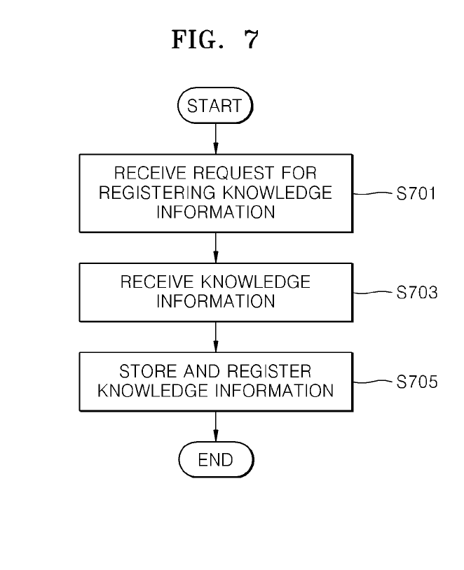

FIG. 7 is a flowchart schematically illustrating a method of registering knowledge information in real time through knowledge server, according to an embodiment of the present invention.

Referring to FIG. 7, the knowledge server 400 receives a request for registering knowledge information from the second user terminal 200. The knowledge server 400 may certify the second user terminal 200 that transmits the request.

In operation S703, the knowledge server 400 receives knowledge information from the second user terminal 200 that is certified to register knowledge information. The knowledge server 400 may receive a classification area and a difficulty level of the knowledge information along with the knowledge information from the second user terminal 200.

In operation S705, the knowledge server 400 stores the received knowledge information in the DB 470 according to a classification system and a difficulty level to register the knowledge information. The knowledge server 400 may store the received knowledge information based on the classification area and the difficulty level of the knowledge information received from the second user terminal 200. Alternatively, the knowledge server 400 may store the received knowledge information according to preset classification area and difficulty level criteria. The preset classification area and difficulty level criteria may be changed. The knowledge server 400 may register the knowledge information in real time to update the DB 470.

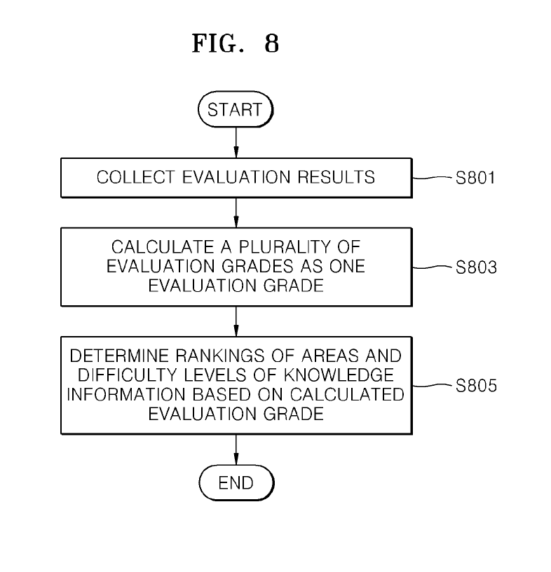

FIG. 8 is a flowchart schematically illustrating a method of determining a ranking based on evaluation of knowledge information through a knowledge server, according to an embodiment of the present invention.

Referring to FIG. 8, in operation S801, the knowledge server 400 collects evaluation contents that are acquired by using various methods. The knowledge server 400 may request a plurality of user terminals, for example, the first user terminal 100 and/or the third user terminal 300, to evaluate knowledge information and receive evaluation results (evaluation grades) from the first user terminal 100 and/or the third user terminal 300. Besides this, the knowledge server 400 may collect evaluation grades of the knowledge information according to an evaluation criterion thereof.

In operation S803, the knowledge server 400 calculates one evaluation result based on evaluation grades that are acquired or collected through at least two evaluation methods. In this case, different weights may be applied to the at least two evaluation methods. The knowledge server 400 may collect evaluation results of the same knowledge information from the plurality of user terminals and determine a ranking of each knowledge information based on the collected evaluation results.

In operation S805, the knowledge server 400 determines rankings of knowledge information that is stored according to areas and difficulty levels and a user who uploads the knowledge information, based on calculated evaluation result or calculated various evaluation results. The knowledge server 400 may provide the determined ranking of the knowledge information to the first user terminal 100 and/or the second user terminal 200.

Raking information determined by a knowledge server may be displayed together if a user terminal searches for knowledge information. In other words, if the user terminal searches for a particular keyword, searched knowledge result may be displayed along with grade and ranking information of a user who uploads the knowledge information.

Besides this, the knowledge server may provide knowledge information stored in various forms to a user terminal. In other words, the knowledge server may request a user terminal that downloads knowledge information having a high ranking to pay preset charge. A user terminal that uploads knowledge information may set payment policy to request preset charge from a user terminal that downloads the knowledge information. In this case, the user terminal may set (request) the knowledge server to request preset payment when or after the user terminal uploads the knowledge information.

The knowledge information uploaded to the knowledge server may be classified according to areas and difficulty levels. Also, rankings of the uploaded knowledge information and a user who uploads the knowledge information may be determined through at least two evaluation methods. In addition, preset payment of downloaded knowledge information may be requested to a user who downloads the knowledge information according to a request of a user terminal that uploads the knowledge information or the knowledge server.

Besides this, the knowledge server may determine a ranking of knowledge information that is uploaded according to areas and difficulty levels (difficulty levels), weeks, months, years, districts, nations, or through the world or a ranking of a user who uploads the knowledge information.

As described above, according to the one or more of the above embodiments of the present invention, a method and apparatus may classify and store knowledge information uploaded in real time by a user according to areas and knowledge levels (difficulty levels). Therefore, the user who wants to download the knowledge information may be conveniently provided with desired knowledge information in real time.

Also, knowledge information stored in a knowledge server may be evaluated by using various methods, and the evaluation result may be provided to a user who uploads knowledge information or a user who wants to download knowledge information. Therefore, the user who uploads the knowledge information tries to upload highly reliable knowledge information, and the user who wants to download the knowledge information may select and download higher reliable knowledge information.

A user who uploads knowledge information in the knowledge server may request preset payments from a user who wants to download knowledge information. Therefore, knowledge information uploaded to the knowledge server may be maintained at a high quality, and charged tutoring trades are activated between unspecified persons.

The present invention may also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves. The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While one or more embodiments of the present invention have been described with reference to the figures, it will be understood by those of ordinary skill in the art that various changes in form and details may be made therein without departing from the spirit and scope of the present invention as defined by the following claims.

What is claimed is:

1. A method of providing knowledge information in real time through a server, the method comprising:
receiving a search word from a first user terminal; and
extracting knowledge information corresponding to the search word according to difficulty levels from a database (DB); and
providing the extracted knowledge information to the first user terminal.

2. The method of claim 1, wherein the providing of the knowledge information comprises:
providing the first user terminal with a list of the knowledge information extracted according to the difficulty levels; and
receiving a difficulty level selected from the list from the first user terminal and providing knowledge information having the selected difficulty level to the first user terminal.

3. The method of claim 1, wherein the extracting of the knowledge information comprises:
determining a classification area to which the search word belongs; and
extracting knowledge information corresponding to the search word according to difficulty levels from the determined classification area of the DB.

4. The method of claim 1, wherein knowledge information of each difficulty level comprises a plurality of pieces of knowledge information related to the search word.

5. The method of claim 1, further comprising:
requesting the first user terminal to evaluate the provided knowledge information and receiving an evaluation result from the first user terminal.

6. The method of claim 1, further comprising:
collecting evaluation results of the same knowledge information from a plurality of user terminals and determining a ranking of knowledge information based on the collected evaluation results.

7. The method of claim 6, wherein the determining of the ranking of the knowledge information comprises:
applying different weights to the evaluation results received from the plurality of user terminals to calculate a final evaluation result.

8. The method of claim 1, wherein the providing of the knowledge information comprises:
providing a ranking of the provided knowledge information along with the knowledge information.

9. The method of claim 1, further comprising:
receiving a request for registering knowledge information from a user terminal; and
storing the requested knowledge information in the DB based on a classification system and a difficulty level.

10. The method of claim 9, wherein the receiving of the request for registering the knowledge information comprises:
receiving a classification area and a difficulty level of the received knowledge information from the second user terminal.

11. An apparatus for providing knowledge information, the apparatus comprising:
a DB which stores knowledge information according to difficulty levels; and
a knowledge information extracting module which extracts knowledge information corresponding to a search word received from a first user terminal according to difficulty levels from the DB and provides the extracted knowledge information to the first user terminal.

12. The apparatus of claim 11, wherein the knowledge information extracting module provides the first user terminal with a list of the extracted knowledge information and provides the first user terminal with knowledge information having a difficulty level selected by the first user terminal.

13. The apparatus of claim 11, wherein the knowledge information extracting module determines a classification area to which the search word belongs and extracts knowledge information corresponding to the search word according to difficulty levels from the determined classification area of the DB.

14. The apparatus of claim 11, wherein knowledge information of each difficulty level comprises a plurality of pieces of knowledge information related to the search word.

15. The apparatus of claim 11, further comprising:
an evaluating module which requests the first user terminal to evaluate the provided knowledge information and receives an evaluation result from the first user terminal.

16. The apparatus of claim 11, wherein the evaluating module collects evaluation results of the same knowledge information from a plurality of user terminals and determines a ranking of knowledge information based on the collected evaluation results.

17. The apparatus of claim 16, wherein the evaluating module applies different weights to the evaluation results received from the plurality of user terminals to calculate a final evaluation result.

18. The apparatus of claim 11, wherein the evaluating module provides a ranking of the provided knowledge information.

19. The apparatus of claim 11, further comprising:
a knowledge information registering module which receives knowledge information from a second user terminal and stores the received knowledge information in the DB based on a classification system and a difficulty level.

20. The apparatus of claim 19, wherein the knowledge information registering module receives a classification area and a difficulty level of the received knowledge information from the second user terminal.
